(19) United States
(12) Patent Application Publication
(10) Pub. No.: US 2006/0074744 A1
(43) Pub. Date: Apr. 6, 2006

(54) Method and electronic device for creating personalized content

(75) Inventors: Maarten Peter Bodlaender, Eindhoven (NL); Michael Alex Van Hartskamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,234

(22) PCT Filed: Nov. 4, 2003
(86) PCT No.: PCT/IB03/05038

§ 371 Date: May 24, 2005

(30) Foreign Application Priority Data
Nov. 28, 2002 (EP) 02079974.8

(51) Int. Cl. G06Q 30/00

(52) U.S. Cl. 705/14

(57) ABSTRACT

In the method of creating a personalized content item, a first descriptor (2) describing a content item (1,100) is compared (6) with a second descriptor (4) describing a personal media item (3,64) and the personal media item (3,64) is incorporated (8) into the content item (1,100) if a relation exists between the first (2) and the second descriptor (4). The electronic device for creating a personalized content item contains a receiver (22), an interface (24), and a control unit (28). The receiver is able to receive a signal comprising a content item described by a first descriptor. The control unit (28) is able to use the interface to retrieve a personal media item described by a second descriptor from a storage means and to execute the method of the invention. The system contains a component (42) which is able to insert a first descriptor describing a content item into a signal comprising the content item and to transmit the signal, a component (44) which is able to store one or more personal media items described by one or more second descriptors, and a component (46) which is able to receive the signal and to execute the method of the invention. The computer program product comprises functions for executing the method of the invention.

The invention relates to a method of creating a personalized content item, comprising the step of incorporating a personal media item in a content item.

The invention further relates to an electronic device which is able to create a personalized content item.

The invention further relates to a system which is able to create a personalized content item.

The invention further relates to a computer program product for creating a personalized content item.

An embodiment of the method is known from WO 01/50416. The known method provides a capture area for a user, elicits a performance from the user, and captures said performance by recording audio and/or video using a video camera A recording of an acceptable performance is automatically composed and/or edited into a pre-recorded and/or dynamic audio and/or video template. The resulting personalized content is stored for later delivery.

It is a drawback of the known method that a performance has to be elicited from a user before personalized content can be created. The actions that need to be performed by the user depend on the pre-recorded and/or dynamic audio and/or video template.

It is a first object of the invention to provide a method of the kind described in the opening paragraph, which allows incorporation of an existing media item in suitable pre-recorded and/or dynamic content.

It is a second object of the invention to provide an electronic device of the kind described in the opening paragraph, which is able to incorporate an existing media item in suitable pre-recorded and/or dynamic content.

It is a third object of the invention to provide a system of the kind described in the opening paragraph, which is able to incorporate an existing media item in suitable pre-recorded and/or dynamic content.

It is a fourth object of the invention to provide a computer program product of the kind described in the opening paragraph, which can be used to incorporate an existing media item in suitable pre-recorded and/or dynamic content.

According to the invention, the first object is realized in that the method further comprises the step of comparing a first descriptor describing the content item with a second descriptor describing the personal media item; and incorporating the personal media item in the content item if a relation exists between the first and the second descriptor. A second descriptor for a vacation photograph may, for instance, comprise ‘vacation, Hawaii, island’ and a first descriptor for a tropical beverage commercial may, for instance, comprise ‘tropical, island, beverage, Maloa’. A relation between the two descriptors may for instance comprise the presence of ‘island’ in both descriptors or the presence of ‘Hawaii’ in the second descriptor and the presence of ‘tropical’ in the first descriptor, Hawaii being a tropical state in the United States. By incorporating the vacation photograph in the beverage commercial, an existing media item is incorporated in suitable pre-recorded and/or dynamic content. A personal media item might be incorporated in a content item before the content item is transmitted to a consumer or the personal media item might be incorporated by a consumer electronic device. A content item and a personal media item may each comprise audio, video, text, images, graphics, or any combination thereof A content item may be for example, a web page comprising a banner advertisement. A descriptor may comprise one or more keywords in a readable format, e.g. XML, or in a coded format. The format may be open or proprietary. A vocabulary of keywords may be limited or unlimited.

In an embodiment of the method of the invention, the step of incorporating a personal media item in a content item comprises incorporating a personal photo in the content item. An increasing number of people possesses a collection of digital photographs, which can easily be incorporated in content items. Although personal audio recordings and personal movies may also be incorporated in content items, personal photographs advantageously can be displayed for a short duration while providing the same nostalgic effect.

Further steps may comprise composing a text by using at least one of the descriptors and incorporating the text into the content item. By incorporating a text, the relation between the personal media item and the content item may be emphasized. For example, a text ‘relive your Hawaii vacation with Maloa’ could accompany a vacation photograph incorporated into a tropical beverage commercial.

The step of incorporating a personal media item into a content item may comprise incorporating the personal media item into a commercial. Commercials are most likely to benefit from personalization, because they are often of less interest to viewers than other types of content.

The step of incorporating a personal media item into a content item may comprise incorporating the personal media item into a marked part of the content item. Content items may be adapted to provide an area where a personal media item may be incorporated, e.g. an area of a screen in a certain set of frames. This allows mixing personal media items and non-personal media items in the same screen. For example, two photographs could be shown simultaneously, one showing a vacation photograph and one showing a tropical beverage. It also prevents an annoying interruption of a commercial, which might occur if a personal media item were to be incorporated in a random area of a screen or inserted randomly in a commercial.

Alternatively, the step of incorporating a personal media item into a content item may comprise inserting the personal media item in at least one of the following positions: before a first and after a last frame of the content item. This feature is advantageous if it is not convenient or possible to adapt a content item. Commercials are most likely to benefit from this feature, because they have a short duration and therefore allow the showing of multiple personal media items in a relatively short period. A frame of the content item may be, for example, an audio, a video, or a synchronized audio and video frame.

A further step may comprise generating at least one of the descriptors by using content analysis. Content items might be provided without descriptors or creating descriptors might take a lot of effort. Content analysis may solve both problems. Analysis of a vacation photograph may be, for example, generate a descriptor comprising ‘island, tropical, water’.

According to the invention, the second object is realized in that the electronic device comprises: a receiver which is able to receive a signal comprising a content item described by a first descriptor; a first interface for interfacing with a first storage means storing a personal media collection comprising a personal media item described by a second descriptor; and a control unit which is able to use the first interface to retrieve the personal media item from the first storage means, to compare the first descriptor with the second descriptor, and to incorporate the personal media item into the content item if a relation exists between the first and the second descriptor. An electronic device of the invention may be, for example, a TV, a DVD-recorder, or a personal video recorder.

An embodiment of the device of the invention further comprises a second interface for interfacing with a second storage means storing a collection of second descriptors; and the control unit is able to use the second interface to retrieve the second descriptor from the second storage means. The first and the second storage means may be logically or physically different parts of the same hardware. This embodiment is advantageous if the control unit is not able to generate the second descriptor, if the control unit generates the second descriptor poorly, or if a collection of second descriptors is already provided.

The control unit may be able to generate at least one of the descriptors using content analysis. This feature is advantageous if the first descriptor is not comprised in the signal and not retrievable in any other way. This feature is also advantageous if the second descriptor is not stored in the personal media collection or on any other storage means.

According to the invention, the third object is realized in that the system comprises: a component which is able to insert a first descriptor describing a content item into a signal comprising the content item and to transmit the signal; a component which is able to store a personal media collection comprising a personal media item described by a second descriptor; and a component which is able to receive the signal, to compare the first descriptor with the second descriptor, and to incorporate the personal media item into the content item if a relation exists between the first and the second descriptor.

According to the invention, the fourth object is realized in that the computer program product comprises functions for: comparing a first descriptor describing a content item with a second descriptor describing a personal media item; and incorporating the personal media item into the content item if a relation exists between the first and the second descriptor.

These and other aspects of the method, the device, the system, and the computer program product of the invention will be further elucidated and described with reference to the drawing, in which:

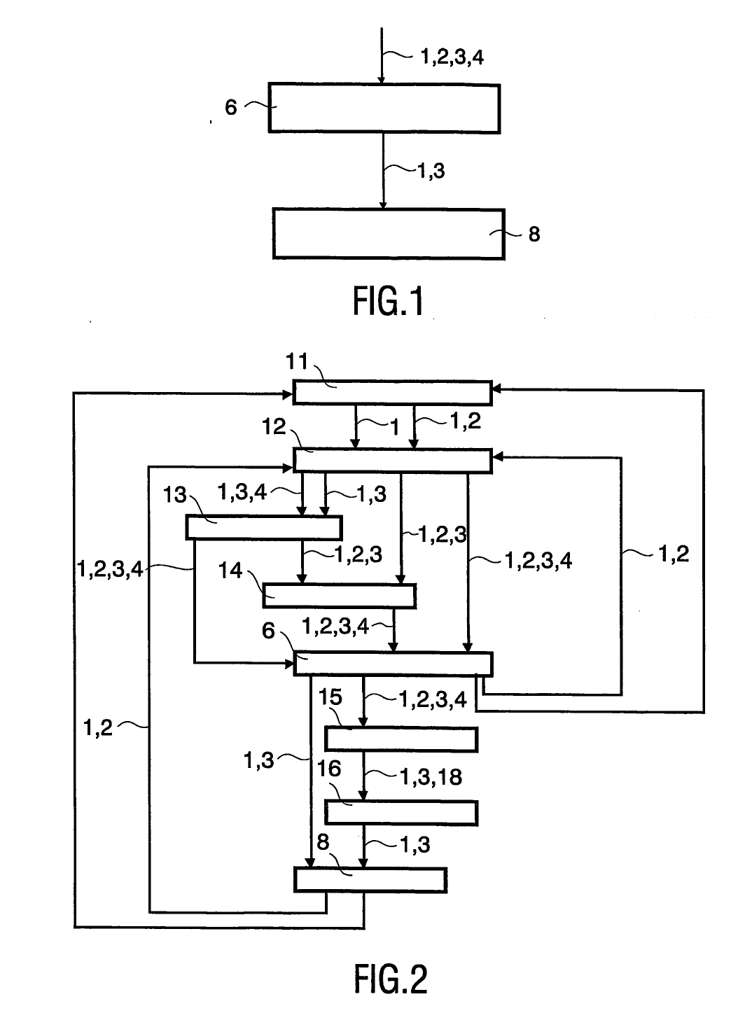

FIG. 1 is a flow chart of the method of the invention;

FIG. 2 is a flow charts of an embodiment of the method of the invention;

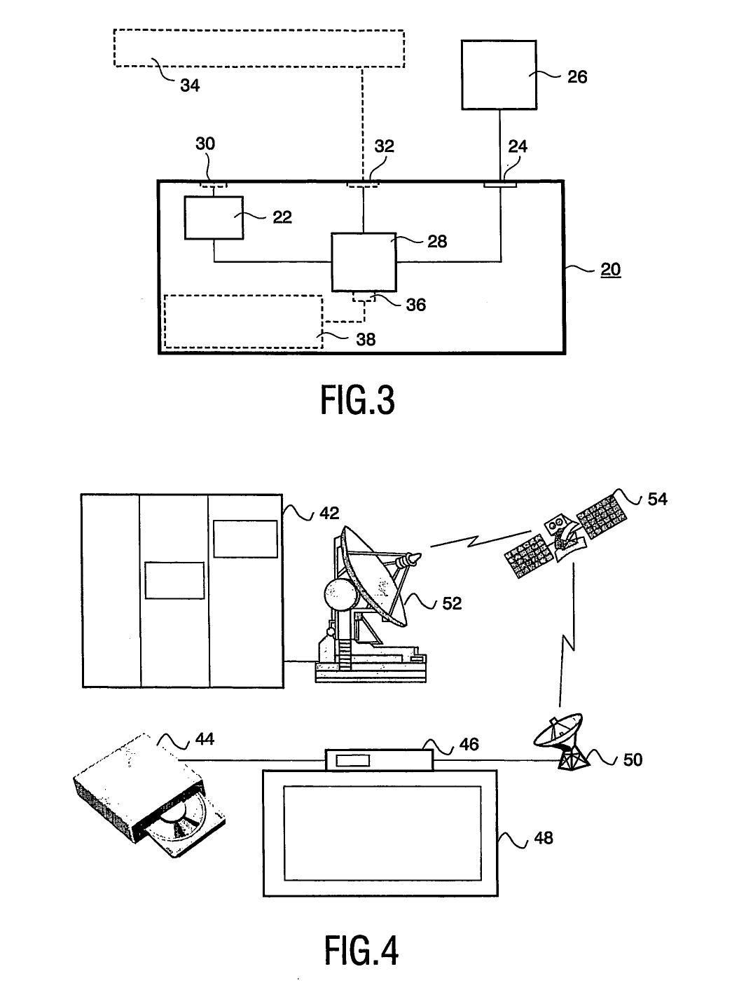

FIG. 3 is a block diagram of an embodiment of the electronic device of the invention;

FIG. 4 is a block diagram of an embodiment of the system of the invention;

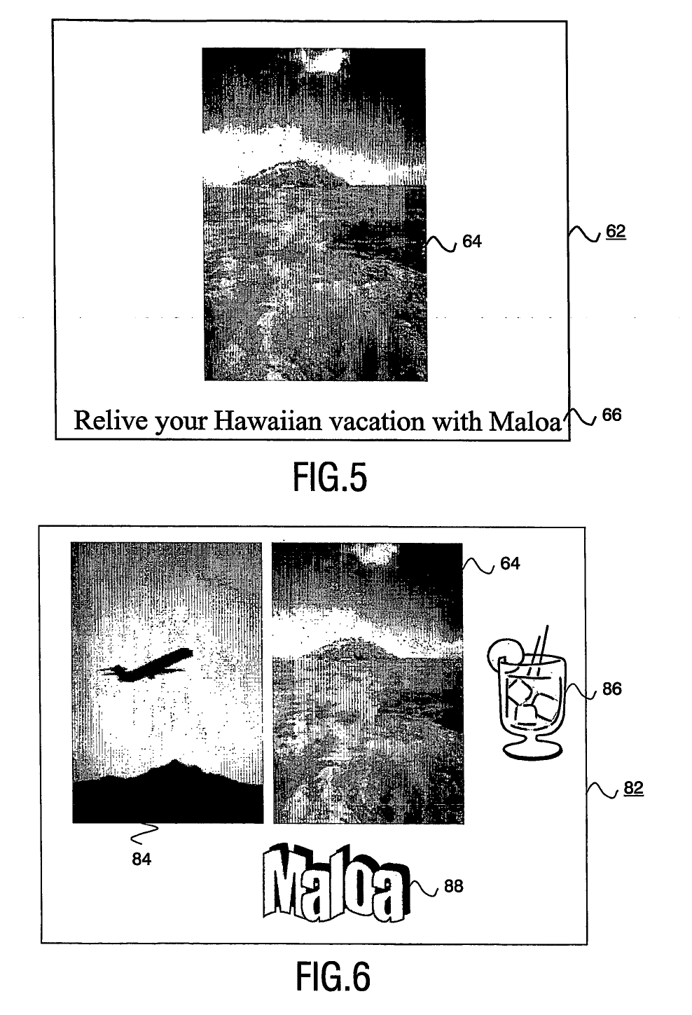

FIG. 5 is a first example of a personalized video frame;

FIG. 6 is a second example of a personalized video frame;

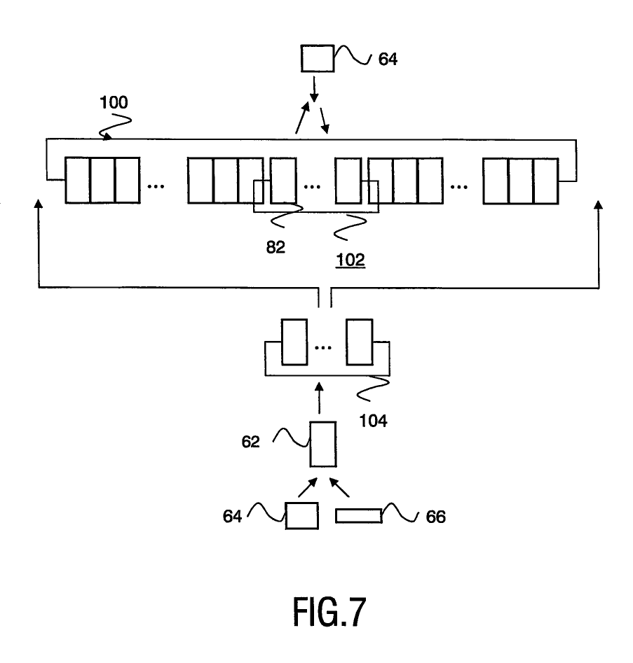

FIG. 7 is a schematic representation of a part of FIG. 1 with regard to FIG. 5 and FIG. 6;

Corresponding elements in the drawings are identified by the same reference numerals.

In FIG. 1, the method of creating a personalized content item comprises step 6 comparing a first descriptor 2 describing a content item 1 with a second descriptor 4 describing a personal media item 3 and step 8 incorporating the personal media item 3 into the content item 1 if a relation exists between the first descriptor 2 and the second descriptor 4. Step 8 is only executed when a relation exists between the first descriptor 2 and the second descriptor 4.

If multiple relations exist between a first descriptor 2 and multiple second descriptors 4 of multiple personal media items 3, at least one of the personal media items 3 may be selected for incorporation into a content item 1. If multiple relations exist between a second descriptor 4 and multiple first descriptors 2 of multiple content items 1, at least one of the content items 1 may be selected and a personal media item 3 may be incorporated into the at least one content item. A first or a random matching personal media item or content item may be selected or selection may be based on the number of times a personal media item or content item has been shown and/or on the time at which a personal media or content item was last shown. Personal media items of poor quality may be shown less often than personal media items of good quality.

In FIG. 2, an embodiment of the method of creating a personalized content item comprises steps 6 and 8 of FIG. 1. The method may also comprise step 11 receiving the content item 1 and optionally first descriptor 2 and step 12 retrieving the personal media item 3 and optionally second descriptor 4. The order in which personal media items are retrieved may be adapted to allow a selection of one of the personal media items if multiple relations exist, e.g. retrieving random personal media items to allow random selection of matching personal media items. The method may comprise step 13 generating the first descriptor 2 for the content item 1 using content analysis and/or step 14 generating a second descriptor 4 for the personal media item 3 using content analysis.

The method may comprise step 15 composing a text 18 using at least one of the descriptors 2 and 4 and step 16 incorporating the text 18 into the content item 1. Steps 15 and 16 should only be executed when a relation exists between the first descriptor 2 and the second descriptor 4. If no such relation exists in step 6, step 11 or step 12 may be executed depending on whether other personal media items 3 are available. After step 8, a further personal media item 3 may be retrieved in step 12 if multiple personal media items 3 should be incorporated in the content item 1 and other personal media items 3 are available. Otherwise, step 11 maybe executed.

In another embodiment of the method of the invention, a personal media item may be received and a content item may be retrieved. A storage means may for example determine when a personal media item should be incorporated into a content item and initiate transmission of the personal media item to an electronic device executing the method of the invention. After receiving the personal media item, the electronic device may be able to retrieve a suitable content item.

In FIG. 3, the electronic device 20 for creating personalized content comprises a receiver 22, a first interface 24 for interfacing with a first storage means 26, and a control unit 28. The electronic device of the invention may be, for example, a TV, a DVD-recorder, or a personal video recorder. The receiver 22 is able to receive a signal comprising a content item described by a first descriptor. The receiver 22 may be able to receive signals through the air and/or through a cable. A cable may be connected through connector 30 to a cable operator or to a satellite receiver. The receiver 22 may be able to receive signals from an Internet service provider. The first storage means 26 is able to store a personal media collection comprising a personal media item described by a second descriptor. The control unit 28 is able to use the first interface 24 to retrieve the personal media item from the first storage means 26, to compare the first descriptor with the second descriptor, and to incorporate the personal media item into the content item if a relation exists between the first and the second descriptor. The control unit 28 may be able to display a personalized content item using a display 34 connected through connector 32. The control unit 28 may be a microprocessor. The display 34 may be, for example, a CRT, plasma, LCD, or LCOS television. A connector 32 may be, for example, a EURO-SCART, a composite, or a component video connector.

The electronic device 20 may further comprise a second interface 36 for interfacing with a second storage means 38 storing a collection of second descriptors. The electronic device 20 may be able to use the second interface 36 to retrieve the second descriptor from the second storage means 38. The control unit 28 may be able to generate at least one of the descriptors using content analysis. The first storage means 26 and the second storage means 38 may be comprised in the electronic device 20 or in an external device. The first storage means 26 and the second storage means 38 may be physically or logically different parts of the same hardware. The first interface and the second interface may be physically or logically different parts of the same hardware. The first storage means 26 and the second storage means 38 may each comprise a non-volatile random access memory, magnetic media, or optical media. The first interface 24 and the second interface 36 may be, for example, a memory bus, an IDE interface, a USB interface, or an IEEE 1394 interface

In FIG. 4, the system comprises a component 42 which is able to insert a first descriptor describing a content item into a signal comprising the content item and to transmit the signal. The system further comprises a component 44 which is able to store a personal media collection comprising a personal media item described by a second descriptor. The system also comprises a component 46 which is able to receive the signal, to compare the first descriptor with the second descriptor, and to incorporate the personal media item into the content item if a relation exists between the first and the second descriptor. The component 42 may use a satellite dish 52 to transmit the signal to a satellite 54 and component 46 may use a satellite dish 50 to receive the signal from the satellite 54. Alternatively, components 42 and 46 may communicate using other wireless or wired communication technologies. The component 46 may be able to detect the component 44 by using Universal Plug and Play technology. The component 46 may display a personalized content item using display 48, e.g. a CRT or plasma television. The component 46 may also play a personalized content item using loudspeakers.

Step 8 of FIG. 1 incorporating the personal media item into the content item may comprise incorporating a personal photo into the content item. Step 8 of FIG. 1 incorporating the personal media item into the content item may also comprise incorporating the personal media item into a commercial. In FIG. 5 and FIG. 6, a vacation photograph of a tropical island is shown incorporated into a video frame of a commercial. A first descriptor describes the content item. A second descriptor describes the personal media item.

The result of executing step 15 of FIG. 2 composing a text by using at least one of the descriptors and step 16 of FIG. 2 incorporating the text into the content item is shown in FIG. 5. FIG. 5 shows a video frame 62 incorporating a vacation photograph 64 and a text 66. The vacation photograph 64 shows an island in Hawaii. The text 66 reads ‘Relive your Hawaiian vacation with Maloa’. Maloa is the name of an imaginary tropical beverage. A second descriptor for the vacation photograph may, for instance, comprise ‘vacation, Hawaii, island’ and a first descriptor for a tropical beverage commercial may, for instance, comprise ‘tropical, island, beverage, Maloa’. A text template for a relation between a first descriptor comprising ‘tropical, beverage’ and a second descriptor comprising ‘vacation’ may, for instance, comprise ‘Relive you <location> vacation with <name>’. Hawaii may be recognized as a location and Maloa may be recognized as a name of a beverage. Alternatively, a descriptor may comprise keyword type and keyword, e.g. ‘name=Maloa’ or ‘location=Hawaii’. Hawaii and Maloa may be inserted in the text template in order to compose text 66.

Step 8 of FIG. 1 incorporating the personal media item into the content item may comprise incorporating the personal media item into a marked part of the content item. In FIG. 6, a video frame 82 of a commercial comprises a photograph of an airplane 84, a drawing of a Maloa tropical beverage 86 and a trademark of Maloa 88. The video frame 82 is personalized by incorporating the personal photograph 64 into a marked area. An area of a video frame may be marked by using a certain color in that area or by drawing certain lines around that area A part of a content item comprising video may be regarded as marked if all video frames in that part comprise at least one marked area A part of a content item may also be marked by embedding non-visible and/or non-audible information describing that part in a signal comprising the content item.

FIG. 7 illustrates the method of incorporating a personal media item into a marked part of a content item with regard to the example of FIG. 6. The content item comprises video frames 100. A content item may alternatively comprise audio frames or synchronized audio and video frames. The video frames 100 comprise marked video frames 102. The marked video frames 102 comprise video frame 82. In FIG. 7, the marked video frames 102 are removed from the video frames 100 and subsequently a personal photograph 64 is incorporated into a marked part of the marked video frames 102. Finally, the personalized marked video frames 102 are inserted into the video frames 100 in the position from which they were previously removed.

Step 8 of FIG. 1 incorporating the personal media item into the content item may comprise inserting the personal media item in at least one of the following positions: before a first and after a last frame of the content item. This is illustrated in FIG. 7 with regard to the example of FIG. 5. In FIG. 7, a personal photograph 64 and a text 66 are incorporated into a new video frame 62. The personal photograph 64 may be retrieved from a storage means. The text 66 may be composed using at least one of the descriptors. The video frame 62 is duplicated to create a set of frames 104. The set of frames 104 may be inserted before and/or after the video frames 100.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. A ‘Computer Program’ is to be understood to mean any software product stored on a computer-readable medium, such as a floppy disk, downloadable via a network, such as the Internet, or marketable in any other manner.

1. A method of creating a personalized content item, comprising the step of: incorporating (8) a personal media item (3,64) into a content item (1,100), characterized in that method further comprises the step of:
comparing (6) a first descriptor (2) describing the content item (1,100) with a second descriptor (4) describing the personal media item (3,64); and
incorporating (8) the personal media item (3,64) into the content item (1,100) if a relation exists between the first (2) and the second descriptor (4).

2. A method as claimed in claim 1, characterized in that the step of incorporating (8) the personal media item (3,64) into the content item (1,100) comprises incorporating a personal photo (64) into the content item (1,100).

3. A method as claimed in claim 1, characterized in that further steps comprise composing (15) a text (18,66) by using at least one of the descriptors (2,4) and incorporating (16) the text (18,66) into the content item (1,100).

4. A method as claimed in claim 1, characterized in that the step of incorporating (8) the personal media item (3,64) into the content item (1,100) comprises incorporating the personal media item (3, 64) into a commercial (100).

5. A method as claimed in claim 1, characterized in that the step of incorporating (8) the personal media item (3,64) into the content item (1,100) comprises incorporating the personal media item (3,64) into a marked part (102) of the content item.

6. A method as claimed in claim 1, characterized in that the step of incorporating (8) the personal media item (3,64) into the content item (1,100) comprises inserting the personal media item (3,64) in at least one of the following positions: before a first and after a last frame of the content item (1,100).

7. A method as claimed in claim 1, characterized in that a further step comprises generating (13,14) at least one of the descriptors (2,4) using content analysis.

8. An electronic device (20) for creating personalized content, comprising:
a receiver (22) which is able to receive a signal comprising a content item described by a first descriptor;
a first interface (24) for interfacing with a first storage means (26) storing a personal media collection comprising a personal media item described by a second descriptor; and
a control unit (28) which is able to use the first interface (24) to retrieve the personal media item from the first storage means (26), to compare the first descriptor with the second descriptor, and to incorporate the personal media item into the content item if a relation exists between the first and the second descriptor.

9. An electronic device (20) as claimed in claim 8, characterized in that it further comprises:
a second interface (36) for interfacing with a second storage means (38) storing a collection of second descriptors; and in that the control unit is able to use the second interface (36) to retrieve the second descriptor from the second storage means (38).

10. An electronic device (20) as claimed in claim 8, characterized in that the control unit (28) is able to generate at least one of the descriptors using content analysis.

11. A system for creating personalized content, comprising:
a component (42) which is able to insert a first descriptor describing a content item into a signal comprising the content item and to transmit the signal;
a component (44) which is able to store a personal media collection comprising a personal media item described by a second descriptor; and
a component (46) which is able to receive the signal, to compare the first descriptor with the second descriptor, and to incorporate the personal media item into the content item if a relation exists between the first and the second descriptor.

12. A computer program product for creating personalized content, comprising functions for:
comparing a first descriptor describing a content item with a second descriptor describing a personal media item; and
incorporating the personal media item into the content item if a relation exists between the first and the second descriptor.
